(19) United States
(12) Patent Application Publication
(10) Pub. No.: US 2018/0179322 A1
(43) Pub. Date: Jun. 28, 2018

(54) SILICONE SURFACTANT FOR USE IN POLYURETHANE FOAMS PREPARED WITH POLYETHER CARBONATE POLYLOS

(71) Applicant: Momentive Performance Materials Inc., Waterford, NY (US)

(72) Inventors: Antonie Gabriel Kiss, Koln (DE); Ladislau Heisler, Marietta, OH (US)

(21) Appl. No.: 15/580,365

(22) PCT Filed: Jun. 9, 2016
(86) PCT No.: PCT/US2016/036643

§ 371 Date: Dec. 7, 2017

Related U.S. Application Data
(60) Provisional application No. 62/174,154, filed on Jun. 11, 2015.

(51) Int. Cl. C08G 18/44; C08G 18/48; C08G 18/18; C08G 18/24

(52) U.S. Cl. CPC C08G 18/44; C08G 18/4837; C08G 2101/0008; C08G 18/244; C08G 18/1833

(57) ABSTRACT

Surfactants for polyurethane foam forming compositions, polyurethane foam forming compositions, and polyurethane foams formed by such compositions. The polyurethane foam forming compositions employ (i) a silicone based surfactant comprising polyether groups pendant from the silicone backbone, and (ii) a polyol component comprising a polyether carbonate polyol, where the surfactant comprises low molecular weight pendant group having a high ethylene oxide content.

### CROSS-REFERENCE TO RELATED APPLICATIONS

The present application claims priority to and the benefit of U.S. Provisional Application No. 62/174,154 filed Jun. 11, 2015 and titled “Silicone Surfactant for Use in Polyurethane Foams Prepared with Polyether Carbonate Polyols,” the disclosure of which is incorporated herein by reference in its entirety.

### FIELD

The present technology relates to silicone based surfactants for use in polyurethane foams, polyurethane foam compositions comprising such surfactants, and polyurethane foams made from such compositions. In particular, the present technology provides a silicone based surfactant that is suitable for making polyurethane foams, including flexible foams, using polyether carbonate polyols.

### BACKGROUND

Polyurethane foams are extensively used in a variety of industrial and consumer applications. The general production of polyurethane foams is well known to those skilled in the art. Polyurethanes are produced from the reaction of isocyanate groups present in polyisocyanates with hydroxyl groups present in polyols. The polyurethane foam production, the reaction of polyisocyanates with polyols, is carried out in the presence of several additives: surfactants, catalysts, cross-linking agents, water, blowing agents, and other additives. Surfactants are typically necessary during the polyurethane foam manufacturing process, and have a significant impact on the final polyurethane foam physical properties. Most conventional type surfactants are based on siloxane/polyether copolymers. Flexible polyurethane foams, a subcategory of the polyurethane foams, are generally soft, less dense, pliable, and subject to structural rebound subsequent to loading.

Polyols used in the production of polyurethanes are typically petrochemical in origin, being generally derived from propylene oxide, ethylene oxide, and various starters such as propylene glycol, glycerin, sucrose, and sorbitol. Polyether polyols are the most common polyols used in polyurethane production. For flexible foams, polyester or polyether polyols with molecular weights of from about 500 to 10,000 are generally used. These types of polyols contribute to the depletion of petroleum-derived oil, a non-renewable resource.

Thus, in recent years, other polyols have been sought for use in making foams. Vegetable oils based polyols have penetrated a variety of polyurethane applications. Growing consumer demand for “greener” products and the depletion of non-renewable resources have created increasing demand for polyurethane foams produced with renewable content. Derived from renewable resources, vegetable oils based polyols, also known as “natural oil based polyols” (NOP), present an alternative to petroleum-based feedstock. As both polyols suppliers and polyurethane foam producers have recognized this opportunity, NOP are increasingly used in a broad range of polyurethane foams, in combination with petroleum based polyols.

NOP currently used in polyurethane foams are usually based on at least one vegetable oil, including but not limited to soybean, castor, sunflower, canola, linseed, cottonseed, tung, palm, poppy seed, corn and peanut. In one respect, NOP may generally be categorized as hydroxylated vegetable oils or alkoxylated vegetable oils, depending on the extent and the nature of the chemical modifications the vegetable oils are subjected to. These are commercially available from various manufacturers.

Polyether carbonate polyols have also been proposed as an alternative polyol to the petroleum-based polyols. Polyether carbonate polyols are made by copolymerizing a starter molecule (propylene glycol, glycerin, sucrose and sorbitol) with carbon dioxide and an alkylene oxide, resulting in polyol with incorporated carbon dioxide content from 1 wt % to about 40 wt %. The use of petroleum-based polyols in polyurethane foams is a well-established technology that has created products with strict industry requirements. The attempt to partially or totally substitute them with NOP or polyether carbonate polyols in the manufacturing of polyurethane foams has, however, resulted in loss of product quality. This is especially true in the case of flexible polyurethane foams, where increasing incorporation of NOP or polyether carbonate polyol has a negative impact on the physical properties of the foam.

### SUMMARY

The present technology relates to silicone surfactants for use in polyurethane foams. More particularly, the present embodiments relate to silicone surfactants having dimethyl siloxane backbones with attached alkyl and polyether pendant groups that provide improved properties for flexible urethane foam compositions utilizing polyether carbonate polyols.

The present technology employs a silicone based surfactant having high molecular weight and low molecular weight polyether pendant groups, where the low molecular weight polyether pendant groups have a high ethylene oxide content. In embodiments, the low molecular weight polyether pendant groups have an ethylene oxide content of 70 weight percent of the alkylene oxide content or greater. It has been found that a foam forming composition comprising such surfactants can employ a substantial amount a polyether carbonate polyol as the polyol component. Using such surfactants allows for at least half and possibly all of the polyol in the composition to be a polyether carbonate polyol. These compositions can provide stable flexible foams with good properties.

In one aspect, the present technology provides, a foam forming composition comprising (a) a polyol comprising a polyether carbonate polyol; (b) an organic polyisocyanate or polyisocyanate prepolymer; (c) a catalyst for the production of polyurethane foams; (d) a blowing agent; and (e) a silicone surfactant, the silicone surfactant comprising a first set of polyether pendant groups having a first molecular weight, and a second set of polyether pendent groups having a second molecular weight, the second molecular weight being lower than the first molecular weight, wherein the second set of polyether pendant groups have an ethylene oxide content of 70% or greater.

In one embodiment, the second set of polyether pendant groups have an ethylene oxide content of 70% to 100%.

In one embodiment of the foam forming composition of any previous embodiment, the second set of polyether pendant groups have an ethylene oxide content of 100%.

In one embodiment of the foam forming composition of any previous embodiment, the second set of polyether pendant groups have a blend average molecular weight of from about 130 to about 1000 grams/mole.

In one embodiment of the foam forming composition of any previous embodiment, the second set of polyether pendant groups have a blend average molecular weight of from about 400 to about 600 grams/mole.

In one embodiment of the foam forming composition of any previous embodiment, the silicone surfactant is of the formula:

MDₓD′_{y}M

wherein M is independently R(CH₂)₂SiO_{1/2}— or (CH₃)₃SiO_{1/2}—; D is —O_{1/2}Si(CH₃)₂O_{1/2}—; D′ is chosen from a group of the formula:

—O_{1/2}Si(CH₃)R¹O_{1/2}—; and/or

—O_{1/2}Si(CH₃)R²O_{1/2}—

where R¹ and R² are polyalkylene oxide polyethers of the formula

—B—CₙH₂ₙO—(C₂H₄O)ₑ—(C₃H₆O)_{f}—Z

where:

R¹ has a blend average molecular weight in the range of from about 1500 to about 6000 grams/mole; n is 3-4; e is a number such that the ethylene oxide (EO) is from about 30 to about 50 weight percent of the alkylene oxide content of the polyether; f is a number such that the propylene oxide residues constitute about 50 to about 70 weight percent of the alkylene oxide content of the polyether;

R² has a blend average molecular weight in the range of from about 130 to about 1000 grams/mole; n is 3-4; e is a number such that the ethylene oxide content is from 70 to about 100 weight percent of the alkylene oxide content of the polyether; f is a number such that the propylene oxide content is from 0 to 30 weight percent of the alkylene oxide content of the polyether;

R is alkyl, aryl or R′, where R′ comprises an acetoxy capped polyether

B is derived from a moiety capable of undergoing hydrosilation;

Z is independently chosen from hydrogen, a C₁-C₈ alkyl or aralkyl moietie, —C(O)Z¹, —C(O)OZ¹, and —C(O)NHZ¹, where Z¹ represents mono-functional C₁-C₈ alkyl or C₆-C₁₂ aryl moieties;
x is 40 to 150; y is 5 to 40; x/y≤15; and

D′ comprises at least one —O_{1/2}Si(CH₃)R²O_{1/2}— group.

In one embodiment of the foam forming composition of any previous embodiment, the silicone surfactant is a silicone polymer of the formula:

R³—Si(CH₃)₂O—(Si(CH₃)₂O—)ₓ—(SiCH₃R⁴O)ₐ—(SiCH₃R⁵O—)_{b}—(SiCH₃R⁶O—)_{c}—Si(CH₃)₂—R³

where R⁴, R⁵, and R⁶ are polyalkylene oxide polyethers of the formula

—B—CₙH₂ₙO—(C₂H₄O)ₑ—(C₃H₆O)_{f}—(C₄H₈O)_{g}—Z,

R⁴ has a blend average molecular weight in the range of from about 3000 to about 6000 grams/mole and ethylene oxide (EO) is from about 20 to about 60 weight percent of the alkylene oxide content of the polyether;

R⁵ has a blend average molecular weight in the range of from about 1100 to about 2900 grams/mole and ethylene oxide is from about 20 to about 60 weight percent of the alkylene oxide content of the polyether;

R⁶ has a blend average molecular weight in the range of from about 130 to about 1000 grams/mole and ethylene oxide is from 70 to about 100 weight percent of the alkylene oxide content of the polyether;

B is derived from a moiety capable of undergoing hydrosilation;

Z is selected from the group consisting of hydrogen, C₁-C₈ alkyl or aralkyl moieties, —C(O)Z¹, —C(O)OZ¹, and —C(O)NHZ¹, where Z¹ represents mono-functional C₁-C₈ alkyl or aryl moieties;

each R³ is independently chosen from an alkyl, an aryl, an aralkyl, R⁴, R⁵, and R⁶;

x is 40 to 150;

y is 5 to 40 and equals a+b+c, where b may be 0, c is greater than 0, and a+b>0; x/y≤15; n≤4; and e, f, and g are independently selected to have any value such that the defined weight percent of EO and molecular weight required by the polyether are met.

In one embodiment of the foam forming composition of any previous embodiment, the polyol (a) comprises the polyether carbonate polyol in an amount of about 50 wt. % or greater.

In one embodiment of the foam forming composition of any previous embodiment, the polyol (a) comprises the polyether carbonate polyol in an amount of 70 wt. % or greater.

In one embodiment of the foam forming composition of any previous embodiment, the polyol (a) comprises the polyether carbonate polyol in an amount of from about 60 wt. % to about 90 wt. %.

In one embodiment of the foam forming composition of any previous embodiment, the polyol (a) comprises the polyether carbonate polyol in an amount of about 100 wt. %.

In one embodiment of the foam forming composition of any previous embodiment, the surfactant (e) is present in an amount of about 0.1 to about 5 parts per hundred parts polyol.

In another aspect, the present technology provides a process for producing a polyurethane foam comprising reacting the foam forming composition of any previous embodiment.

In still another aspect, the present technology provides a polyurethane foam formed from the foam forming compositions of any previous embodiment.

### DETAILED DESCRIPTION

In one aspect, the present invention provides a foam forming composition comprising (a) a polyol comprising a polyether carbonate polyol; (b) an organic polyisocyanate or polyisocyanate prepolymer; (c) at least one catalyst for the production of polyurethane foams; (d) at least one blowing agent; and (e) a silicone surfactant. The silicone surfactant comprises a silicone-based polymer surfactant comprising polyether based groups pendant to a silicon atom in the backbone of the silicone-based polymer. By controlling the polyether groups in terms of their molecular weight and/or ethylene oxide content, it has been found that a polyurethane foam composition can be provided using polyether carbonate polyols to make flexible foams having good properties.

The silicone surfactant suitable for use in the present invention may be referred to as a “comb-type” silicone polymer and comprise polyether groups pendant to the silicon atoms in the polymer backbone. In particular, the surfactant comprises both low molecular weight polyether pendant groups and high molecular weight polyether pendant groups, where the low molecular weight polyether pendant groups have a high ethylene oxide content.

In one embodiment, the surfactant is a polymer of the formula:

MDₓD′_{y}M

wherein M is independently R(CH₂)₂SiO_{1/2}— or (CH₃)₃SiO_{1/2}—; D is —O_{1/2}Si(CH₃)₂O_{1/2}—; D′ is —O_{1/2}Si(CH₃)R′O_{1/2}—; x is 40 to 150; y is 5 to 40; x/y≤15; R is alkyl, aryl or R′; and R′ comprises an acetoxy capped polyether. The surfactant comprises at least two different D′ groups having different polyethers from one another with one of the polyether branches having ≥70% by weight ethylene oxide content. The surfactant has a target average molecular weight of about 12,000 to about 35,000 Daltons. In one embodiment, the surfactant comprises two different polyether groups. In one embodiment, the surfactant comprises three different capped polyether groups. In one embodiment, the target average molecular weight is from about 20,000 to about 30,000 Daltons; from about 22,000 to about 28,000 Dalton; even from about 24,000 to about 26,000 Daltons. In embodiments, the target average molecular weight is about 12,000 to about 20,000 Daltons; even 12,000 to about 15,000 Daltons. Here as elsewhere in the specification and claims, numerical values can be combined to form new and non-disclosed ranges.

In one embodiment, the D′ group is chosen from a group of the formula:

—O_{1/2}Si(CH₃)R¹O_{1/2}—; and/or

—O_{1/2}Si(CH₃)R²O_{1/2}—

where R¹ and R² are polyalkylene oxide polyethers of the formula

—B—CₙH₂ₙO—(C₂H₄O)ₑ—(C₃H₆O)_{f}—Z

where:

R¹ has a blend average molecular weight in the range of from about 1500 to about 6000 grams/mole; n is 3-4; e is a number such that the ethylene oxide (EO) is from about 30 to about 50 weight percent of the alkylene oxide content of the polyether; f is a number such that the propylene oxide residues constitute about 50 to about 70 weight percent of the alkylene oxide content of the polyether;

R² has a blend average molecular weight in the range of from about 130 to about 1000 grams/mole; n is 3-4; e is a number such that the ethylene oxide content is from 70 to about 100 weight percent of the alkylene oxide content of the polyether; f is a number such that the propylene oxide content is from 0 to 30 weight percent of the alkylene oxide content of the polyether;

B is derived from a moiety capable of undergoing hydrosilation;

Z is independently chosen from hydrogen, C₁-C₈ alkyl or aralkyl moieties, —C(O)Z¹, —C(O)OZ¹, and —C(O)NHZ¹, where Z¹ represents mono-functional C₁-C₈ alkyl or C₆-C₁₂ aryl moieties; and

D′ comprises at least one —O_{1/2}Si(CH₃)R²O_{1/2}— group.

As described above, M may be a R(CH₂)₂SiO_{1/2}— group, where R may optionally be an acetoxy capped polyether, R′. The acetoxy capped polyether R′ may be independently chosen from the polyalkylene oxide polyethers R¹ and R². In embodiments, the surfactant comprises one M group with a polyalkylene oxide group. In one embodiment, the M group comprises a polyalkylene oxide polyether chosen from R¹. In on embodiment, the M group comprises a polyalkylene oxide group chosen from R². In embodiments, each M group comprises a polyalkylene oxide group. In one embodiment, one M group comprises a polyalkylene oxide chosen from R¹, and one M group comprises a polyalkylene oxide chosen from R². In one embodiment, each M group comprises a polyalkylene oxide chosen from R¹. In one embodiment, each M group comprises a polyalkylene oxide chosen from R². When each M group comprises a R¹ or R² group, the groups may be the same or different from one another.

In one embodiment, R¹ has a blend average molecular weight in the range of from about 2000 to about 5000 grams/mole; n is 3-4; e is a number such that the ethylene oxide (EO) is from about 35 to about 45 weight percent of the alkylene oxide content of the polyether; f is a number such that the propylene oxide residues constitute about 50 to about 70 weight percent of the alkylene oxide content of the polyether; and R² has a blend average molecular weight in the range of from about 250 to about 750 grams/mole; n is 3-4; e is a number such that the ethylene oxide content is from 70 to about 100 weight percent of the alkylene oxide content of the polyether; f is a number such that the propylene oxide content is from 0 to 30 weight percent of the alkylene oxide content of the polyether. In one embodiment, R² has a blend average molecular weight in the range of from about 250 to about 750 grams/mole; from about 300 to about 700 grams/mole; even from about 400 to about 600 grams/mole.

In one embodiment, the silicone surfactant is a silicone polymer of the formula:

R³—Si(CH₃)₂O—(Si(CH₃)₂O—)ₓ—(SiCH₃R⁴O—)ₐ—(SiCH₃R⁵O—)_{b}—(SiCH₃R⁶O—)_{c}—Si(CH₃)₂—R³

where R⁴, R⁵, and R⁶ are polyalkylene oxide polyethers of the formula

—B—CₙH₂ₙO—(C₂H₄O)ₑ—(C₃H₆O)_{f}—(C₄H₈O)_{g}—Z,

R⁴ has a blend average molecular weight in the range of from about 3000 to about 6000 grams/mole and ethylene oxide (EO) is from about 20 to about 60 weight percent of the alkylene oxide content of the polyether;

R⁵ has a blend average molecular weight in the range of from about 1100 to about 2900 grams/mole and ethylene oxide is from about 20 to about 60 weight percent of the alkylene oxide content of the polyether;

R⁶ has a blend average molecular weight in the range of from about 130 to about 1000 grams/mole and ethylene oxide is from 70 to about 100 weight percent of the alkylene oxide content of the polyether;

B is derived from a moiety capable of undergoing hydrosilation;

Z is selected from the group consisting of hydrogen, C₁-C₈ alkyl or aralkyl moieties, —C(O)Z¹, —C(O)OZ¹, and —C(O)NHZ¹, where Z¹ represents mono-functional C₁-C₈ alkyl or aryl moieties;

each R³ is independently chosen from an alkyl, an aryl, an aralkyl, R⁴, R⁵, and R⁶;

x is 40 to 150;

y is 5 to 40 and equals a+b+c, where b may be 0, c is greater than 0, and a+b>0; x/y≤15; n≤4; and e, f, and g are independently selected to have any value such that the defined weight percent of EO and molecular weight required by the polyether are met.

The R⁴ moieties may comprise from about 30 to about 55% by weight of EO; from about 35 to about 50% by weight of EO; even about 40 to about 50% of EO. In one embodiment, R⁴ comprises about 40% EO. The R⁴ moieties may have a BAMW greater than 3500 Daltons and, in one embodiment, greater than 4000 Daltons. In one embodiment, the R⁴ moieties have a BAMW of from about 3500 to about 5000 Daltons in one embodiment from about 4000 to about 4500 Dalton. The R⁵ moieties may have from about 30 to about 55% by weight of EO; from about 35 to about 50% by weight of EO; even about 40 to about 50% of EO. In one embodiment, R⁵ comprises about 40% EO. The R⁵ moieties may have a BAMW in the range of from about 1000 to about 2500 Daltons; from about 1100 to 2300 Daltons; from about 1200 to about 2000 Daltons; from about 1300 to about 1800 Daltons. In one embodiment, about 1400 to about 1600 Daltons. The R⁶ moieties range from 70 up to about 100% by weight of EO; from about 75 to about 95% by weight of EO; even from about 80 to about 90% by weight of EO. In one embodiment, R⁶ comprises from about 70 to about 80% EO. The R⁶ moieties may have a BAMW in the range of from about 250 to about 750 Daltons; from about 300 to about 700 Daltons; even from about 400 to about 600 Daltons.

There may also be more than one different polyether from each group. For example, a copolymer may comprise (a) two R⁴-type polyethers differing in molecular weight and/or EO-content, e.g., 55% EO of 4000 MW and 44% EO of 5500 MW, and (b) an R⁶-type polyether. In addition, butylene oxide can be substituted for propylene oxide in the polyether backbone. The polyether moieties can be linear or branched and can contain any number of carbon atoms.

The alkyl pendant groups, R³, can be C₁-C₁₂ substituted or unsubstituted alkyl groups, C₆-C₁₂ aryl groups, or C₆-C₁₂ alkaryl groups. In one embodiment, Z is —C(O)CH₃ or CH₃. B may be an allyl derivative, e.g., propyl, or a methallyl derivative, e.g., isobutyl.

In accordance with the present invention, the silicone surfactants have a x/y ratio of less than or equal to 15. In one embodiment, the x/y ratio is about 2 to about 15; about 3 to about 10; about 4 to about 7; about 4 to about 6. The ratio of x/y includes all whole number and fractional ratios. Here as elsewhere in the specification and claims, numerical values may be combined to form new and non-disclosed ranges.

As described herein, the value “y” is the sum of a+b+c. It will be appreciated that the surfactant can comprise any combination of these units with the proviso that c is not 0 (i.e., the surfactant comprises at least one c unit) and a+b>0. In one embodiment, the silicone surfactant comprises a, b, and d units.

The surfactant can be used in the polyurethane foam-forming compositions at a concentration of from about 0.1 to about 5 pphp, more particularly in an amount of from about 0.1 to about 3 pphp and even more particularly in an amount of from about 0.6 to about 2 pphp, where pphp means parts per hundred parts polyol.

The surfactant can be provided as a surfactant composition comprising the surfactant and a diluent. The concentration of the surfactant in the surfactant composition can be selected as desired for a particular purpose or intended use. In one embodiment, the surfactant concentration in the surfactant composition can be from about 10% to about 50% by weight of the surfactant composition, more particularly from about 15% to about 75%, and even more particularly from about 20% to about 50% by weight, based upon the weight of the surfactant composition.

The polyol (a) component comprises a polyether carbonate polyol. Polyether carbonate polyols are derived from an H-functional starter or initiator (e.g., a monofunctional or polyhydric alcohols), an alkylene oxide, and carbon dioxide. The polyether carbonate is not particularly limited and can be chosen from any suitable polyether carbonate as desired for a particular purpose or intended application.

The polyether carbonate polyols may have a functionality of at least 1, at least 2, even at least 4. In embodiments, the polyether carbonate polyol has a functionality of from 1 to 8, from 2 to 8, from 2 to 6, and even from 2 to 4. The molecular weight may be from 400 to 10,000 g/mol, even from 500 to 6000 g/mol. The polyether carbonate polyol may comprise from about 1% to about 40% by weight of carbon dioxide; from about 5% to about 30% by weight of carbon dioxide; from about 10% to about 25% by weight of carbon dioxide; even from about 15% to about 20% by weight of carbon dioxide.

Again, the polyether carbonate polyol is not particularly limited. In embodiments, the polyether carbonate polyol may be a compound of the formula:

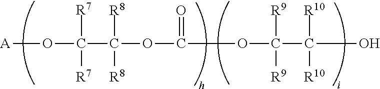

where each occurrence of R⁷, R⁸, R⁹, and R¹⁰ is independently chosen from hydrogen, a halogen, a C1-C10 alkyl, and a C6-C30 aryl; and A represents a residue from an H-functional starter substance. In embodiments, each occurrence of R⁷, R⁸, R⁹, and R¹⁰ is hydrogen.

In embodiments, alkylene oxides having from 2 to 24 carbon atoms can be used to form the polyether carbonate polyol. Alkylene oxides having from 2 to 24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or poly-epoxidised fats as mono-, di- and tri-glycerides, epoxidised fatty acids, C₁-C₂₄-esters of epoxidised fatty acids, epichlorohydrin, glycidol and derivatives of glycidol such as, for example, methyl glycidyl ether, ethyl glycidyl ether, 2-ethylhexyl glycidyl ether, allyl glycidyl ether, glycidyl methacrylate as well as epoxide-functional alkyloxysilanes such as, for example, 3-glycidyloxypropyltrimethoxysilane, 3-glycidyloxypropyltriethoxysilane, 3-glycidyloxypropyltripropoxysilane, 3-glycidyloxypropyl-methyl-dimethoxysilane, 3-glycidyloxypropyl-ethyldiethoxysilane, 3-glycidyloxypropyltriisopropoxysilane. Ethylene oxide and/or propylene oxide, in particular propylene oxide, are preferably used as the alkylene oxides.

Suitable H-functional starter substances to form the polyether carbonate may be chosen from a compound having H atoms active for the alkoxylation. Groups that have active H atoms and which are active for the alkoxylation are, for example, —OH, —NH₂ (primary amines), —NH— (secondary amines), —SH and —CO₂H; —OH is particularly suitable. In embodiments, the H-functional starter substance may be, for example, one or more compounds selected from mono- or poly-hydric alcohols, mono- or poly-valent amines, polyvalent thiols, carboxylic acids, aminoalcohols, aminocarboxylic acids, thioalcohols, hydroxy esters, polyether polyols, polyester polyols, polyester ether polyols, polyether carbonate polyols, polycarbonate polyols, polycarbonates, polyethyleneimines, polyether amines (e.g. so-called Jeffamine® from Huntsman, such as, for example, D-230, D-400, D-2000, T-403, T-3000, T-5000 or corresponding products from BASF, such as, for example, polyether amine D230, D400, D200, T403, T5000), polytetrahydrofurans (e.g. PolyTHF® from BASF, such as, for example, PolyTHF® 250, 650S, 1000, 1000S, 1400, 1800, 2000), polytetrahydrofuranamines (BASF product polytetrahydrofuranamine 1700), polyether thiols, polyacrylate polyols, castor oil, the mono- or di-glyceride of ricinoleic acid, monoglycerides of fatty acids, chemically modified mono-, di- and/or tri-glycerides of fatty acids, and C₁-C₂₄-alkyl fatty acid esters that contain on average at least 2 OH groups per molecule. The C₁-C₂₄-alkyl fatty acid esters that contain on average at least 2 OH groups per molecule are, for example, commercial products such as Lupranol Balance® (BASF AG), Merginol® types (Hobum Oleochemicals GmbH), Sovermol® types (Cognis Deutschland GmbH & Co. KG) and Soyol®™ types (USSC Co.).

Suitable monofunctional starter substances include, for example, alcohols, amines, thiols and carboxylic acids. Suitable monofunctional alcohols include: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Suitable monofunctional amines include: butylamine, tert-butylamine, pentylamine, hexylamine, aniline, aziridine, pyrrolidine, piperidine, morpholine. Suitable monofunctional thiols include, but are not limited to: ethanethiol, 1-propanethiol, 2-propanethiol, 1-butanethiol, 3-methyl-1-butanethiol, 2-butene-1-thiol, thiophenol. Suitable monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols suitable as H-functional starter substances are, for example, dihydric alcohols (such as, for example, ethylene glycol, diethylene glycol, propylene glycol, dipropylene glycol, 1,3-propanediol, 1,4-butanediol, 1,4-butenediol, 1,4-butynediol, neopentyl glycol, 1,5-pentanediol, methylpentanediols (such as, for example, 3-methyl-1,5-pentanediol), 1,6-hexanediol; 1,8-octanediol, 1,10-decanediol, 1,12-dodecanediol, bis-(hydroxymethyl)-cyclohexanes (such as, for example, 1,4-bis-(hydroxymethyl)cyclohexane), triethylene glycol, tetraethylene glycol, polyethylene glycols, dipropylene glycol, tripropylene glycol, polypropylene glycols, dibutylene glycol and polybutylene glycols); trihydric alcohols (such as, for example, trimethylolpropane, glycerol, trishydroxyethyl isocyanurate, castor oil); tetrahydric alcohols (such as, for example, pentaerythritol); polyalcohols (such as, for example, sorbitol, hexitol, sucrose, starch, starch hydrolysates, cellulose, cellulose hydrolysates, hydroxy-functionalised fats and oils, in particular castor oil), as well as all modification products of the above-mentioned alcohols with different amounts of ε-caprolactone.

The H-functional starter substances can also be selected from the substance class of the polyether polyols, in particular those having a molecular weight Mn in the range from 100 to 4000 g/mol. Preference is given to polyether polyols that are composed of repeating ethylene oxide and propylene oxide units, preferably having a content of from 35 to 100% propylene oxide units, particularly preferably having a content of from 50 to 100% propylene oxide units. The polyether polyol starter substance may be chosen from random copolymers, gradient copolymers, alternating or block copolymers of ethylene oxide and propylene oxide. Suitable polyether polyols composed of repeating propylene oxide and/or ethylene oxide units include, for example, the Desmophen®, Acclaim®, Arcol®, Baycoll®, Bayfill®, Bayflex®, Baygal®, PET® and polyether polyols from Covestro (such as, for example, Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S 180). Further suitable homo-polyethylene oxides are, for example, the Pluriol® E brands from BASF SE, suitable homo-polypropylene oxides are, for example, the Pluriol® P brands from BASF SE, suitable mixed copolymers of ethylene oxide and propylene oxide are, for example, the Pluronic® PE or Pluriol® RPE brands from BASF SE.

The H-functional starter substances can also be selected from the substance class of the polyester polyols, in particular those having a molecular weight Mn in the range from 200 to 4500 g/mol. At least difunctional polyesters are used as polyester polyols. Polyester polyols may consist of alternating acid and alcohol units. Suitable acid components may comprise, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the mentioned acids and/or anhydrides. Suitable alcohol components may comprise, for example, ethanediol, 1,2-propanediol, 1,3-propanediol, 1,4-butanediol, 1,5-pentanediol, neopentyl glycol, 1,6-hexanediol, 1,4-bis-(hydroxymethyl)-cyclohexane, diethylene glycol, dipropylene glycol, trimethylolpropane, glycerol, pentaerythritol or mixtures of the mentioned alcohols. If divalent or polyvalent polyether polyols are used as the alcohol component, polyester ether polyols which can likewise be used as starter substances for the preparation of the polyether carbonate polyols are obtained. In embodiments, polyether polyols with Mn=from 150 to 2000 g/mol are used for the preparation of the polyester ether polyols.

Polycarbonate diols can further be used as H-functional starter substances, in particular polycarbonate diols having a molecular weight Mn in the range from 150 to 4500 g/mol, preferably from 500 to 2500 g/mol, which are prepared, for example, by reaction of phosgene, dimethyl carbonate, diethyl carbonate or diphenyl carbonate and difunctional alcohols or polyester polyols or polyether polyols. Examples of polycarbonates are to be found, for example, in EP-A 1359177. Examples of suitable polycarbonate diols include the Desmophen® C types from Bayer MaterialScience AG, such as, for example, Desmophen® C 1100 or Desmophen® C 2200.

In a further embodiment of the invention, polyether carbonate polyols can be used as the H-functional starter substances.

The H-functional starter substances generally have a functionality (i.e. number of H atoms active for the polymerisation per molecule) of from 1 to 8, preferably 2 or 3. The H-functional starter substances are used either individually or in the form of a mixture of at least two H-functional starter substances.

Suitable H-functional starter substances are alcohols of the general formula (II)

HO—(CH₂)ₕ—OH (II)

wherein h is a number from 1 to 20, preferably an even number from 2 to 20. Examples of alcohols according to formula (II) are ethylene glycol, 1,4-butanediol, 1,6-hexanediol, 1,8-octanediol, 1,10-decanediol and 1,12-dodecanediol. Further examples of H-functional starter substances are neopentyl glycol, trimethylolpropane, glycerol, pentaerythritol, reaction products of the alcohols according to formula (II) with ε-caprolactone, for example reaction products of trimethylolpropane with ε-caprolactone, reaction products of glycerol with ε-caprolactone, as well as reaction products of pentaerythritol with ε-caprolactone. Still other examples of H-functional starter substances are diethylene glycol, dipropylene glycol, castor oil, sorbitol, and polyether polyols composed of repeating polyalkylene oxide units.

Particularly suitable H-functional starter substances include, but are not limited to, one or more compounds selected from the group consisting of ethylene glycol, propylene glycol, 1,3-propanediol, 1,3-butanediol, 1,4-butanediol, 1,5-pentanediol, 2-methyl-1,3-propanediol, neopentyl glycol, 1,6-hexanediol, 1,8-octanediol, diethylene glycol, dipropylene glycol, glycerol, trimethylolpropane, di- and tri-functional polyether polyols, the polyether polyol being composed of a di- or tri-H-functional starter substance and propylene oxide or of a di- or tri-H-functional starter substance, propylene oxide and ethylene oxide. The polyether polyols may have a molecular weight Mn in the range from 62 to 4500 g/mol and a functionality of from 2 to 3, and in particular a molecular weight Mn in the range from 62 to 3000 g/mol and a functionality of from 2 to 3.

The preparation of the polyether carbonate polyols is carried out by catalytic addition of carbon dioxide and alkylene oxides to H-functional starter substances. The term “H-functional” is understood as being the number of H atoms active for the alkoxylation per molecule of the starter substance.

The polyether carbonate polyol may comprise up to about 100% of the polyol component (a). In embodiments, the polyol component (a) comprises the polyether carbonate polyol in an amount of 50% or greater; 60% or greater; 70% or greater; 80% or greater; 90% or greater; even 95% or greater. In embodiments, the polyol component (a) comprises the polyether carbonate polyol in an amount of from about 50% to about 100% by weight of the polyol (a); from about 60% to about 90% by weight of the polyol (a); even from about 70% to about 80% by weight of the polyol (a).

In embodiments where the polyol (a) comprises less than 100% of polyether carbonate polyol, the balance of the polyol may be from any polyol as desired. The polyol is normally a liquid polymer possessing hydroxyl groups. The term “polyol” includes linear and branched polyethers (having ether linkages), polyesters and blends thereof, and comprising at least two hydroxyl groups. In one embodiment, the polyol can be at least one of the types generally used to prepare polyurethane foams. A polyether polyol having a weight average molecular weight of from about 1000 to about 10000 is particularly useful. In one embodiment, the polyether polyol has a weight average molecular weight of from about 2000 to about 8000; from about 3000 to about 6000; even from about 4000 to about 5000.

Polyols containing reactive hydrogen atoms generally employed in the production of high-resilience polyurethane foams can be employed in the formulations of the present invention. The polyols are hydroxy-functional chemicals or polymers covering a wide range of compositions of varying molecular weights and hydroxy functionality. These polyhydroxyl compounds are generally mixtures of several components although pure polyhydroxyl compounds, i.e. individual compounds, can in principle be used.

Representative polyols that may be used in conjunction with a polyether carbonate polyol include, but are not limited to, polyether polyols, polyester polyols, polyetherester polyols, polyesterether polyols, polybutadiene polyols, acrylic component-added polyols, acrylic component-dispersed polyols, styrene-added polyols, styrene-dispersed polyols, vinyl-added polyols, vinyl-dispersed polyols, urea-dispersed polyols, polyoxypropylene polyether polyol, mixed poly (oxyethylene/oxypropylene) polyether polyol, polybutadienediols, polyoxyalkylene diols, polyoxyalkylene triols, polytetramethylene glycols, polycaprolactone diols and triols, all of which possess at least two primary hydroxyl groups.

Some specific, non-limiting examples of polyether polyols include, polyoxyalkylene polyol, particularly linear and branched poly(oxyethylene)glycol, poly(oxypropylene)glycol, copolymers of the same and combinations thereof. Non-limiting examples of modified polyether polyols include polyoxypropylene polyether polyol into which is dispersed poly(styrene acrylonitrile) or polyurea, and poly(oxyethylene/oxypropylene) polyether polyols into which is dispersed poly(styrene acrylonitrile) or polyurea.

In one embodiment the polyether polyol is chosen from ARCOL® polyol 1053, ARCOL® E-743, Hyperlite® E-848 from Bayer AG, Voranol® from Dow BASF, Stepanpol®. from Stepan, Terate® from Invista, or combinations of two or more thereof.

The hydroxyl number of a polyol is the number of milligrams of potassium hydroxide required for the complete hydrolysis of the fully acrylated derivative prepared from one gram of polyol. The hydroxyl number is also defined by the following equation, which reflects its relationship with the functionality and molecular weight of the polyol:

OH No.=(56.1×1000×f)/M.W.

wherein OH is the hydroxyl number of the polyol; f is the average functionality, that is, average number of hydroxyl groups per molecule of the polyether polyol; and M.W. is the number average molecular weight of the polyether polyol. The average number of hydroxyl groups in the polyether polyol is achieved by control of the functionality of the initiator or mixture of initiators used in producing the polyether polyol.

In one embodiment, the polyol can have a functionality of from about 2 to about 6; from about 3 to about 5; even about 4. It will be understood by a person skilled in the art that these ranges include all subranges there between.

In one embodiment, the polyurethane foam-forming composition comprises a polyether polyol having a hydroxyl number of from about 10 to about 3000, more particularly from about 20 to about 2000 even more particularly from about 30 to about 1000 and still even more particularly from about 35 to about 800. Here as elsewhere in the specification and claims, numerical values can be combined to form new and non-disclosed ranges.

The polyisocyanate (b) can include any organic compound containing at least two isocyanate groups that can be used for production of polyurethane foam. In one embodiment, the polyisocyanate can be an organic compound that comprises at least two isocyanate groups and generally will be any known or later discovered aromatic or aliphatic polyisocyanates.

In one embodiment, the polyisocyanate can be a hydrocarbon diisocyanate, including alkylenediisocyanate and arylene diisocyanate.

Representative and non-limiting examples of polyisocyanates include toluene diisocyanate, diphenylmethane isocyanate, polymeric versions of toluene diisocyanate and diphenylmethane isocyanate, methylene diphenyl diisocyanate (MDI), 2,4- and 2,6-toluene diisocyanate (TDI), triisocyanates and polymethylene poly(phenylene isocyanates) also known as polymeric or crude MDI and combinations thereof. C available 2,4- and 2,6-toluene diisocyanates include Mondur® TDI.

In one embodiment, the polyisocyanate can be at least one mixture of 2,4-toluene diisocyanate and 2,6-toluene diisocyanate wherein 2,4-toluene diisocyanate is present in an amount of from about 80 to about 85 weight percent of the mixture and wherein 2,6-toluene diisocyanate is present in an amount of from about 20 to about 15 weight percent of the mixture. It will be understood by a person skilled in the art that these ranges include all subranges there between.

The amount of polyisocyanate included in the polyurethane foam-forming composition relative to the amount of other materials in the polyurethane foam-forming composition is described in terms of “Isocyanate Index.” “Isocyanate Index” refers to the actual amount of polyisocyanate used divided by the theoretically required stoichiometric amount of polyisocyanate required to react with all active hydrogen in polyurethane foam-forming composition multiplied by one hundred (100).

In one embodiment, the Isocyanate Index in the polyurethane foam-forming composition is from about 60 to about 300, more particularly from about 70 to about 200, even more particularly from about 80 to about 120. It will be understood by a person skilled in the art that these ranges include all subranges there between.

The catalyst (c) for the production of the polyurethane foams herein can be a single catalyst or mixture of catalysts that can be used to catalyze the reactions of polyol and water with polyisocyanates to form polyurethane foam. It is common, but not required, to use both an organoamine and an organotin compound for this purpose. Other metal catalysts can be used in place of, or in addition to, organotin compound.

Representative examples of the catalyst (c) include, but are not limited to:
tertiary amines such as bis(2,2′-dimethylamino)ethyl ether, trimethylamine, triethylenediamine, 1,8-diazabicyclo[5.4.0]undec-7-ene, triethylamine, N-methylmorpholine, N,N-ethylmorpholine, N,N-dimethylbenzylamine, N,N-dimethylethanolamine, N,N,N′,N′-tetramethyl-1,3-butanediamine, pentamethyldipropylenetriamine, triethanolamine, triethylenediamine, 2-{[2-(2-dimethylaminoethoxy)ethyl]methylamino}ethanol, pyridine oxide, and the like;
strong bases such as alkali and alkaline earth metal hydroxides, alkoxides, phenoxides, and the like;
acidic metal salts of strong acids such as ferric chloride, stannous chloride, antimony trichloride, bismuth nitrate and chloride, and the like;
chelates of various metals such as those which can be obtained from acetylacetone, benzoylacetone, trifluoroacetylacetone, ethyl acetoacetate, salicylaldehyde, cyclopentanone-2-carboxylate, acetylacetoneimine, bis-acetylaceone-alkylenediimines, salicylaldehydeimine, and the like, with various metals such as Be, Mg, Zn, Cd, Pb, Ti, Zr, Sn, As, Bi, Cr, Mo, Mn, Fe, Co, Ni, or such ions as MoO₂++, UO₂++, and the like;
alcoholates and phenolates of various metals such as Ti(OR)₄, Sn(OR)₄, Sn(OR)₂, Al(OR)₃, and the like, wherein R is alkyl or aryl of from 1 to about 12 carbon atoms, and reaction products of alcoholates with carboxylic acids, beta-diketones, and 2-(N,N-dialkylamino) alkanols, such as well known chelates of titanium obtained by this or equivalent procedures;
salts of organic acids with a variety of metals such as alkali metals, alkaline earth metals, Al, Sn, Pb, Mn, Co, Bi, and Cu, including, for example, sodium acetate, potassium laurate, calcium hexanoate, stannous acetate, stannous octoate, stannous oleate, lead octoate, metallic driers such as manganese and cobalt naphthenate, and the like;
organometallic derivatives of tetravalent tin, trivalent and pentavalent As, Sb, and Bi, and metal carbonyls of iron and cobalt; and
combinations of two or more thereof.

In one embodiment, the catalyst (c) is an organotin compound that is a dialkyltin salt of a carboxylic acid, including the non-limiting examples of dibutyltin diacetate, dibutyltin dilaureate, dibutyltin maleate, dilauryltin diacetate, dioctyltin diacetate, dibutyltin-bis(4-methylaminobenzoate), dibuytyltindilaurylmercaptide, dibutyltin-bis(6-methylaminocaproate), and the like, and combinations of two or more thereof.

Similarly, in another embodiment there may be used trialkyltin hydroxide, dialkyltin oxide, dialkyltin dialkoxide, or dialkyltin dichloride, and combinations of two or more thereof can be employed. Non-limiting examples of these compounds include trimethyltin hydroxide, tributyltin hydroxide, trioctyltin hydroxide, dibutyltin oxide, dioctyltin oxide, dilauryltin oxide, dibutyltin-bis(isopropoxide) dibutyltin-bis(2-dimethylaminopentylate), dibutyltin dichloride, dioctyltin dichloride, and the like, and combinations of two or more thereof.

In one embodiment, the catalyst can be an organotin catalyst such as stannous octoate, dibutyltin dilaurate, dibutyltin diacetate, stannous oleate, or combinations of two or more thereof. In another embodiment, the catalyst can be an organoamine catalyst, for example, tertiary amine such as trimethylamine, triethylamine, triethylenediamine, bis(2,2-dimethylamino)ethyl ether, N-ethylmorpholine, diethylenetriamine, 1,8-diazabicyclo[5.4.0]undec-7-ene, or combinations of two or more thereof. In still another embodiment, the catalyst can include mixtures of tertiary amine and glycol, such as Niax® catalyst C-183 (Momentive Performance Materials, Inc.), stannous octoate, such as Niax® catalyst D-19 (Momentive Performance Materials, Inc.), or combinations of two or more thereof.

According to one embodiment of the present invention, the catalyst is an amine catalyst for the production of high resilience flexible slabstock and molded foams. These amine catalysts can be bis(N,N-dimethylaminoethyl)ether or 1,4-diazabicyclo[2.2.2]octane.

In another embodiment amine catalysts can include mixtures of tertiary amine and glycol, such as Niax® catalyst C-183, stannous octoate, such as Niax® catalyst D-19 and combinations thereof, all available from Momentive Performance Materials.

The polyurethane foam-forming composition can include a blowing agent. The blowing agent can be one blowing agent of the physical and/or chemical type. Typical physical blowing agents include, but are not limited to methylene chloride, acetone, water or CO₂, which are used to provide expansion in the foaming process. A typical chemical blowing agent is water, which reacts with isocyanates in the foam, forming reaction mixture to produce carbon dioxide gas. These blowing agents possess varying levels of solubility or compatibility with the other components used in the formation of polyurethane foams. Developing and maintaining a good emulsification when using components with poor compatibility is critical to processing and achieving acceptable polyurethane foam quality.

### EXAMPLES

Polyurethane foams were made using surfactants in accordance with the present technology and polyether carbonate polyols. Comparative examples using conventional surfactants and polyether carbonate polyols were also evaluated. The formulations are described in Table 1:

TABLE 1

| | Foams | | | | | |
|---|---|---|---|---|---|---|
| | Ex 1 | Ex 2 | Ex 3 | | | |
| | Comp | Comp | Comp | Ex 4 | Ex 5 | Ex 6 |
| Polyether Carbonate Polyol (Bayer) | 70 | 70 | 70 | 70 | 70 | 70 |
| Polyether Polyol Arcol 1108 (Bayer) | 30 | 30 | 30 | 30 | 30 | 30 |
| Water | 4.5 | 4.5 | 4.5 | 4.5 | 4.5 | 4.5 |
| Niax ® Catalyst A-1 | 0.12 | 0.12 | 0.12 | 0.12 | 0.12 | 0.12 |
| Niax ® Catalyst Stannous Octoate | 0.2 | 0.2 | 0.2 | 0.2 | 0.2 | 0.2 |
| Silicone A (Tegostab BF2370) | 1.8 | 1 | 0.6 | | | |
| Silicone B | | | | 1.8 | 1 | 0.6 |
| TDI Index | 108 | 108 | 108 | 108 | 108 | 108 |
| Results | | | | | | |
| Rise Time (sec) | 90 | 84 | 80 | 98 | 83 | 90 |
| Final Height (cm) | 23.8 | 24.1 | — | 26.1 | 26.2 | 25.8 |
| Settling (%) | 0.0 | 3.6 | — | 0.0 | 0.0 | 0.0 |
| Density (kg/m3) | 22.8 | 23.3 | — | 21.6 | 21.1 | 21.4 |
| CFD 40% (kPa) | 5.0 | 5.1 | — | 4.4 | 4.4 | 4.4 |
| Comfort factor | 2.1 | 2.1 | — | 2.2 | 2.1 | 2.1 |
| Resilience (%) | 22 | 28 | — | 23 | 25 | 25 |
| Porosity (L/min) | 5 | 67 | — | 20 | 59 | 96 |
| Comments | | | collapse | | | |

TABLE 2

| | Foams | | | | | | |
|---|---|---|---|---|---|---|---|
| | Ex 7 | | Ex 9 | Ex 10 | Ex 11 | | |
| | Comp | Ex 8 | Comp | Comp | Comp | Ex. 12 | Ex. 13 |
| Polyether Carbonate Polyol (Bayer) | 100 | 100 | 100 | 100 | 100 | 100 | 100 |
| Polyether Polyol Arcol 1108 ( Bayer) | | | | | | | |
| Water | 4.5 | 4.5 | 4.5 | 4.5 | 4.5 | 4.5 | 4.5 |
| Niax ® Catalyst A-1 | 0.12 | 0.12 | 0.12 | 0.12 | 0.12 | 0.12 | 0.12 |
| Niax ® Catalyst Stannous Octoate | 0.2 | 0.2 | 0.2 | 0.2 | 0.2 | 0.2 | 0.2 |
| Silicone A (Tegostab BF2370) | 1 | | | | | | |
| Silicone B | | 1 | | | | 0.65 | |
| Silicone C | | | 1 | | | | |
| Silicone D | | | | 1 | | | |
| Silicone E | | | | | 1 | | |
| Silicone F | | | | | | | 0.65 |
| TDI Index | 108 | 108 | 108 | 108 | 108 | 108 | 108 |
| Results | | | | | | | |
| Rise Time (sec) | 87 | 98 | 87 | 84 | 92 | 86 | 86 |
| Final Height (cm) | — | 23.4 | — | — | — | 24.5 | 24.4 |
| Settling (%) | — | 0.8 | — | — | — | 3.9 | 3.2 |
| Density (kg/m3) | — | 23.6 | — | — | — | 22.8 | 23.1 |
| CFD 40% (kPa) | — | 5.4 | — | — | — | 5.9 | 6.1 |
| Comfort factor | — | 2.2 | — | — | — | 2.03 | 2.04 |
| Resilience (%) | — | 16.7 | — | — | — | — | — |
| Porosity (L/min) | — | 27 | — | — | — | 47 | 24 |
| Comments | collapse | | collapse | collapse | collapse | | |

Silicone B (present invention): Silicone polyether surfactant with two polyether substituents—4000 MW polyether containing 40% EO, and 550 MW polyether containing 100% EO.
Silicone C: Silicone polyether surfactant with two polyether substituents—4000 MW polyether containing 40% EO, and 1500 MW polyether containing 40% EO.
Silicone D: Silicone polyether surfactant with two polyether substituents—4000 MW polyether containing 40% EO, and 1500 MW polyether containing 40% EO.
Silicone E: Silicone polyether surfactant with two polyether substituents—4000 MW polyether containing 40% EO, and 550 MW polyether containing 40% EO.
Silicone F (present invention): Silicone polyether surfactant with two polyether substituents—4000 MW polyether containing 40% EO, and 750 MW polyether containing 75% EO.

Examples 1-6 are for foam formulations using a combination of 70% by weight polyether carbonate polyol and 30% by weight petroleum based polyol. Examples 4-6 use Silicone B (a surfactant in accordance with the present technology). As shown, Silicone B is the only one that provides foam stabilization and typical foam properties at three different use levels (0.6, 1.0, and 1.8 parts per hundred parts polyol, pphp). Silicone B provides good foam stabilization as reflected by the higher Final Height values, and 0% Settling. Silicone B provides foam with adequate porosity values. By comparison, Silicone A collapses foam at 0.6 pphp (Example 3), and has increased Settling % at 1.0 pphp (Example 2) indicating poor stabilization of the foam. Silicone A does not provide adequate stabilization as reflected by lower Final Height values in Examples 1 and 2. At increased use levels, Silicone A provides foam with very low porosity (while higher porosity is desired in flexible foam).

Examples 7-13 are foam formulations using 100% by weight polyether carbonate polyol. In these formulations, only the surfactants in accordance with aspects of the invention, e.g., Silicones B and F, provided foam stabilization with adequate foam properties. The other surfactants that were tested did not provide adequate foam stabilization, resulting in foam collapse.

Examples 12 and 13 compare inventive compositions employing silicone surfactants having different ethylene oxide concentrations in the low molecular weight polyether pendent groups. Example 12 employs a surfactant with an EO content of 100% in the low molecular weight polyether substituent. Example 13 employs a surfactant with an EO content of 75% on the low molecular weigh polyether substituent. As shown in Table 2, the surfactant with the EO content of 75% still provides a foam with excellent properties.

Foam compositions were also evaluated with different water content. Using lower water content in the foam composition allows for changing or controlling the foam density. Table 3 shows the results for foams using lower water content.

TABLE 3

| | Foams | | | | | | | | |
|---|---|---|---|---|---|---|---|---|---|
| | | | | | | Ex | Ex | | |
| | Ex 14 | Ex | Ex 16 | Ex 17 | Ex | 19 | 20 | Ex | Ex 22 |
| | Comp | 15 | Comp | Comp | 18 | Comp | Comp | 21 | Comp |
| Polyether Carbonate Polyol | 70 | 70 | 70 | 70 | 70 | 70 | 70 | 70 | 70 |
| (Bayer) | | | | | | | | | |
| Polyether Polyol Arcol 1108 | 30 | 30 | 30 | 30 | 30 | 30 | 30 | 30 | 30 |
| (Bayer) | | | | | | | | | |
| Water | 4.5 | 4.5 | 4.5 | 4.0 | 4.0 | 4.0 | 3.5 | 3.5 | 3.5 |
| Niax ® Catalyst B-18 | 0.15 | 0.15 | 0.15 | 0.15 | 0.15 | 0.15 | 0.15 | 0.15 | 0.15 |
| Niax ® Catalyst Stannous | 0.18 | 0.18 | 0.18 | 0.18 | 0.18 | 0.18 | 0.18 | 0.18 | 0.18 |
| Octoate | | | | | | | | | |
| Silicone A (Tegostab BF2370) | 0.8 | | | 1 | | | 0.8 | | |
| Silicone B (present invention) | | 0.8 | | | 1 | | | 0.8 | |
| Silicone E | | | 0.8 | | | 1 | | | 0.8 |
| TDI Index | 106 | 106 | 106 | 106 | 106 | 106 | 106 | 106 | 106 |
| Results | | | | | | | | | |
| Rise Time (sec) | 84 | 90 | 81 | 88 | 95 | 88 | 92 | 100 | 87 |
| Final Height (cm) | 20.1 | 22.4 | — | 20.3 | 21.8 | 18.6 | 18.9 | 20.6 | 18 |
| Settling (%) | 4.7 | 0 | — | 2.4 | 0 | 6.1 | 1.6 | 0 | 5.8 |
| Density (kg/m3) | 23.9 | 22.1 | — | 26 | 24.4 | 26.4 | 28.9 | 26.7 | 29.2 |
| CFD 40% (kPa) | 4.6 | 3.6 | — | 4.6 | 4.2 | 4.5 | 4.4 | 3.9 | 4.8 |
| Comfort factor | 2.1 | 2.3 | — | 2.2 | 2.2 | 2.2 | 2.2 | 2.2 | 2.1 |
| Resilience (%) | 29 | 26 | — | 28 | 25 | 28 | 29 | 25 | 28 |
| Porosity (L/min) | 101 | 91 | — | 93 | 85 | 91 | 73 | 70 | 52 |
| Comments | | | collapse | | | | | | |

Silicone A: Tegostab BF2370 is from Evonik.
Silicone B (present invention): Silicone polvether surfactant with two polyether substituents—4000 MW polyether containing 40% EO, and 550 MW polyether containing 100% EO.
Silicone E: Silicone poly ether surfactant with two polvether substituents—4000 MW polyether containing 40% EO. and 550 MW polvether containing 40% EO content.

As shown in Table 3, even using different water levels in the compositions, foams employing the present surfactant still exhibit good properties in terms of density, porosity, resilience, etc. while still employing a relatively high concentration of polycarbonate polyol.

The foregoing description identifies various non-limiting embodiments of a surfactant, foam forming composition comprising such surfactants, and foams formed from such compositions. Modifications may occur to those skilled in the art and to those who may make and use the invention. The disclosed embodiments are merely for illustrative purposes and not intended to limit the scope of the invention or the subject matter set forth in the claims.

The Listing of claims replaces all previous versions of the claims:

1. A foam forming composition comprising:
(a) a polyol comprising a polyether carbonate polyol;
(b) an organic polyisocyanate or polyisocyanate prepolymer;
(c) a catalyst for the production of polyurethane foams;
(d) a blowing agent; and
(e) a silicone surfactant, the silicone surfactant comprising a first set of polyether pendant groups having a first molecular weight, and a second set of polyether pendent groups having a second molecular weight, the second molecular weight being lower than the first molecular weight, wherein the second set of polyether pendant groups have an ethylene oxide content of 70% or greater.

2. The foam forming composition of claim 1, wherein the second set of polyether pendant groups have an ethylene oxide content of 70% to 100%.

3. The foam forming composition of claim 1, wherein the second set of polyether pendant groups have an ethylene oxide content of 100%.

4. The foam forming composition of claim 1, wherein the second set of polyether pendant groups have a blend average molecular weight of from about 130 to about 1000 grams/mole.

5. The foam forming composition of claim 1, wherein the second set of polyether pendant groups have a blend average molecular weight of from about 400 to about 600 grams/mole.

6. The foam forming composition of claim 1, wherein the silicone surfactant is of the formula:
wherein M is independently R(CH₂)₂SiO_{1/2}— or (CH₃)₃SiO_{1/2}—; D is —O_{1/2}Si(CH₃)₂O_{1/2}—; D′ is chosen from a group of the formula:
—O_{1/2}Si(CH₃)R¹O_{1/2}—; and/or
—O_{1/2}Si(CH₃)R²O_{1/2}—
where R¹ and R² are polyalkylene oxide polyethers of the formula
—B—CₙH₂ₙO—(C₂H₄O)ₑ—(C₃H₆O)_{f}—Z
where:
R¹ has a blend average molecular weight in the range of from about 1500 to about 6000 grams/mole; n is 3-4; e is a number such that the ethylene oxide (EO) is from about 30 to about 50 weight percent of the alkylene oxide content of the polyether; f is a number such that the propylene oxide residues constitute about 50 to about 70 weight percent of the alkylene oxide content of the polyether;
R² has a blend average molecular weight in the range of from about 130 to about 1000 grams/mole; n is 3-4; e is a number such that the ethylene oxide content is from 70 to about 100 weight percent of the alkylene oxide content of the polyether; f is a number such that the propylene oxide content is from 0 to 30 weight percent of the alkylene oxide content of the polyether;
R is alkyl, aryl or R′, where R′ comprises an acetoxy capped polyether
B is derived from a moiety capable of undergoing hydrosilation;
Z is independently chosen from hydrogen, a C₁-C₈ alkyl or aralkyl moietie, —C(O)Z¹, —C(O)OZ¹, and —C(O)NHZ¹, where Z¹ represents mono-functional C₁-C₈ alkyl or C₆-C₁₂ aryl moieties;
x is 40 to 150; y is 5 to 40; x/y≤15; and
D′ comprises at least one —O_{1/2}Si(CH₃)R²O_{1/2}— group.

7. The foam forming composition of claim 1, wherein the silicone surfactant is a silicone polymer of the formula:
R³—Si(CH₃)₂O—(Si(CH₃)₂O—)ₓ—(SiCH₃R⁴O—)ₐ—(SiCH₃R⁵O—)_{b}—(SiCH₃R⁶O—)_{c}—Si(CH₃)₂—R³
where R⁴, R⁵, and R⁶ are polyalkylene oxide polyethers of the formula
—B—CₙH₂ₙO—(C₂H₄O)ₑ—(C₃H₆O)_{f}—(C₄H₈O)_{g}—Z,
R⁴ has a blend average molecular weight in the range of from about 3000 to about 6000 grams/mole and ethylene oxide (EO) is from about 20 to about 60 weight percent of the alkylene oxide content of the polyether;
R⁵ has a blend average molecular weight in the range of from about 1100 to about 2900 grams/mole and ethylene oxide is from about 20 to about 60 weight percent of the alkylene oxide content of the polyether;
R⁶ has a blend average molecular weight in the range of from about 130 to about 1000 grams/mole and ethylene oxide is from 70 to about 100 weight percent of the alkylene oxide content of the polyether;
B is derived from a moiety capable of undergoing hydrosilation;
Z is selected from the group consisting of hydrogen, C₁-C₈ alkyl or aralkyl moieties, —C(O)Z¹, —C(O)OZ¹, and —C(O)NHZ¹, where Z¹ represents mono-functional C₁-C₈ alkyl or aryl moieties;
each R³ is independently chosen from an alkyl, an aryl, an aralkyl, R⁴, R⁵, and R⁶;
x is 40 to 150;
y is 5 to 40 and equals a+b+c, where b may be 0, c is greater than 0, and a+b>0; x/y≤15; n≤4; and e, f, and g are independently selected to have any value such that the defined weight percent of EO and molecular weight required by the polyether are met.

8. The foam forming composition of claim 1, wherein the polyol (a) comprises the polyether carbonate polyol in an amount of about 50 wt. % or greater.

9. The foam forming composition of claim 1, wherein the polyol (a) comprises the polyether carbonate polyol in an amount of 70 wt. % or greater.

10. The foam forming composition of claim 1, wherein the polyol (a) comprises the polyether carbonate polyol in an amount of from about 60 wt. % to about 90 wt. %.

11. The foam forming composition of claim 1, wherein the polyol (a) comprises the polyether carbonate polyol in an amount of about 100 wt. %.

12. The foam forming composition of claim 1 comprising the surfactant (e) in an amount of about 0.1 to about 5 parts per hundred parts polyol.

13. A process for producing a polyurethane foam comprising reacting the foam forming composition of claim 1.

14. A polyurethane foam formed from the foam forming compositions of claim 1.
